(19) United States
(12) Patent Application Publication
(10) Pub. No.: US 2025/0211705 A1
(43) Pub. Date: Jun. 26, 2025

(54) Thermal Imaging Camera

(71) Applicant: Robert Bosch GmbH, Stuttgart (DE)

(72) Inventors: Axel Rumberg, Karlsruhe (DE); Michael Frank, Bretten (DE); Patrick Meyer, Leinfelden-Echterdingen (DE); Tim Saup, Leinfelden-Echterdingen (DE)

(21) Appl. No.: 18/982,485

(22) Filed: Dec. 16, 2024

(30) Foreign Application Priority Data
Dec. 22, 2023 (DE) 10 2023 213 297.4

(51) Int. Cl. H04N 5/33; G01J 5/00; G01J 5/02; G01J 5/061; G01J 5/48

(52) U.S. Cl. CPC H04N 5/33; G01J 5/025; G01J 5/0265; G01J 5/061; G01J 5/48; G01J 2005/0077

(57) ABSTRACT

A thermal imaging camera includes a housing, an infrared assembly for detecting infrared radiation, and a visual assembly for receiving visual radiation. The infrared assembly and the visual assembly are disposed substantially within the housing. The camera further includes at least one cooling element for cooling at least the infrared assembly. The thermal imaging camera also includes a sensor mount configured to connect the infrared assembly to the cooling element.

This application claims priority under 35 U.S.C. § 119 to application no. DE 10 2023 213 297.4, filed on Dec. 22, 2023 in Germany, the disclosure of which is incorporated herein by reference in its entirety.

The present disclosure relates to a thermal imaging camera.

### BACKGROUND

A handheld thermal imaging camera for contact-free determination of two-dimensional temperature information of a scene, comprising a housing with at least one infrared detector array consisting of a plurality of pixels sensitive to infrared radiation, is already known from DE 10 2016 219 388 A1.

### SUMMARY

The present disclosure proceeds from a thermal imaging camera with a housing, with an infrared assembly for detecting infrared radiation, with a visual assembly for recording visual radiation, wherein the infrared assembly and the visual assembly are substantially disposed within the housing, and with at least one cooling element for cooling at least the infrared assembly. It is proposed that the thermal imaging camera comprises a sensor mount configured to connect the infrared assembly to the cooling element.

The disclosure provides a thermal imaging camera in which thermal influences can be reduced by the sensor mount connecting the infrared assembly to the cooling element.

A “thermal image camera” refers to a device for non-contact measurement of two-dimensional temperature information of a scene which outputs at least one piece of information relating to the two-dimensional temperature information, for example by outputting one or more temperature indicators, advantageously two or more temperature readings, a temperature distribution, or the like. In one embodiment of the thermal imaging camera, this two-dimensional temperature information may be in the form of a thermal image composed of a plurality of spatially-resolved temperature readings and/or temperature readings resolved for the spatial angle.

The thermal imaging camera may be configured as a handheld thermal imaging camera. The “handheld” thermal imaging camera is to be understood in particular to mean that the thermal imaging camera can only be transported with the hands, in particular with one hand, of a user without the aid of a hauling machine. In particular, the thermal imaging camera can also be handheld and guided through a room during a measurement operation in a movement freely performed by the user of the thermal imaging camera. The mass of the handheld thermal imaging camera is in particular less than 5 kg, advantageously less than 3 kg, and particularly advantageously less than 1 kg.

The housing can be configured as a shell housing with two half shells. The housing comprises a handle or a handle area with which the thermal imaging camera can be guided by the user. The housing accommodates at least essential functional components of the thermal imaging camera. Thus, the infrared assembly and the visual assembly are substantially disposed inside the housing. Further, a front bracket, the cooling element, a positioning device and/or the sensor mount may be substantially disposed within the housing. Further, the housing accommodates at least a control unit, an input and/or an output device, in particular a display device, a power supply unit, and an evaluation unit. The thermal imaging camera may comprise at least one operating element configured to operate the thermal imaging camera. Further, the housing may comprise at least one inlet opening into which the visual radiation and/or infrared radiation may enter.

The front bracket may be received by the housing. The front bracket may close off the housing from a surrounding environment. The functional components of the thermal imaging camera may be substantially protected from environmental influences inside the housing. The front bracket has an opening for the infrared assembly and the visual assembly. The front bracket has a receptacle for the visual assembly. The receptacle for the visual assembly is configured to at least partially surround the visual assembly. A face of the visual assembly may abut the receptacle of the front bracket. It is possible that the visual assembly may abut the front bracket, in particular the receptacle of the front bracket, by way of a visual lens. For example, the front bracket may be made of a heat-conductive material such as aluminum.

The visual assembly comprises at least one visual camera for capturing at least one image and/or video in the visual spectrum of radiation, a lens for the visual camera, and a circuit board for the visual camera. The visual assembly, in particular the circuit board for the visual camera, is connected to the control unit to receive signals. The lens for the visual camera is configured to break, bundle, and/or focus the visual radiation and direct it to the visual camera.

In addition, the front bracket comprises a further receptacle. The further receptacle of the front bracket may comprise an adhesive layer or an adhesive pad. The further receptacle of the front bracket is configured to receive at least one infrared window and/or pane of glass for the visual assembly. Further, it is possible that the further receptacle of the front bracket will receive a laser and a lens for a light source, for example, such as an LED. Further, a seal may be applied to and/or glued to the front bracket.

The infrared assembly may comprise an infrared housing, an infrared sensor, an infrared lens, and/or an infrared circuit board. The infrared housing is configured to position the infrared optics relative to the infrared sensor. The infrared sensor may be configured as an infrared detector array. It is also conceivable that the infrared sensor is configured as a bolometer, in particular a micro-bolometer. To measure infrared radiation, the thermal imaging camera comprises the infrared assembly as well as the evaluation unit. The infrared sensor comprises a plurality of pixels sensitive to infrared radiation. The infrared sensor detects infrared radiation radiated in a spatial angle region and projected on its surface and generates a detection signal based on a detected intensity of incident infrared radiation. The infrared sensor has a two-dimensional detecting area on a surface facing the scene, on which the plurality of pixels sensitive to infrared radiation are arranged. Each of the pixels of the infrared detector array can thereby determine—provided that they are illuminated by way of infrared radiation—image information and generate a detection signal therefrom. The detection signal provided by each pixel may then be used to determine temperature information. In particular, the detection signal of each pixel may be forwarded to the evaluation unit of the thermal imaging camera. The detection signal can be evaluated by the evaluation unit individually and/or in combination with detection signals of other pixels. The infrared lens is configured to break, bundle, and/or focus the infrared radiation and direct it onto the infrared sensor. The infrared sensor may be disposed on the infrared circuit board. Thus, the infrared sensor may be disposed between the infrared circuit board and the infrared lens. The infrared circuit board is connected to the control unit and/or the evaluation unit to receive signals, such that the detection signal can be conducted from the infrared assembly to the control unit and/or the evaluation unit. The infrared assembly may at least partially engage with a recess of the front bracket. The infrared assembly can engage the recess by way of the infrared lens. The infrared assembly may define an optical axis, which may be a primary direction of incidence for the infrared radiation. “Axial” is in particular intended to be understood as substantially parallel to the optical axis. Whereas “radial” is intended to be understood as substantially perpendicular to the optical axis.

The thermal imaging camera comprises the control unit at least for controlling the infrared assembly and/or the visual assembly. For this purpose, the control unit is connected to at least the infrared assembly and the visual assembly to receive signals. Further, the control unit is connected to the evaluation unit to receive signals. The control unit can be disposed, for example, in a handle of the handheld tool, in an area of a power supply interface, or in an area of the infrared assembly and/or the visual assembly. The control unit has at least a main circuit board. The main circuit board may be disposed opposite the front bracket. For example, the main circuit board may be disposed towards the output device.

The “evaluation unit” of the thermal imaging camera is to be understood as a unit comprising at least one information input for receiving detection signals, an information processing unit for processing, in particular evaluating the received detection signals, and an information output for passing on the processed and/or evaluated detection signals and/or evaluation information. Advantageously, the evaluation unit contains components comprising at least a processor, a memory, and an operating program with evaluation and calculation routines. In particular, the electronic components of the evaluation unit can be arranged on a board or printed circuit board, preferably on a common board with the control unit of the thermal imaging camera for controlling the thermal imaging camera. Furthermore, the control unit and the evaluation unit can also be designed as a single component, for example in the form of a microcontroller. The evaluation unit is provided to evaluate detection signals generated by the infrared detector array, in particular from the pixels which can be connected to the analysis unit to receive signals, and to perform an analysis of the two-dimensional temperature information of the scene based on the detection signals of at least a plurality of illuminated pixels of the infrared detector array. Preferably, the evaluation unit is provided to perform an evaluation of one or more temperature metrics, in particular also averaged temperature metrics, particularly preferably a thermal image, based on the detection signals of at least a plurality of illuminated pixels. In this way, the evaluation unit serves to determine the two-dimensional temperature information, in particular the thermal image, from measured infrared radiation. The evaluated two-dimensional temperature information, in particular the thermal image, may be provided by the evaluation unit for further processing and/or output to the user of the thermal imaging camera by way of the output device and/or an external device via a data communication interface.

The output device is configured to represent the two-dimensional temperature information, in particular the thermal image, and to provide and display information to the user. The output device can be designed as a display, for example. The output device may be disposed opposite the front bracket on the housing. For example, the output device may play the images or videos of the visual assembly and/or the detection signal of the infrared assembly.

The input device is configured to receive and at least forward input from the user to the control unit. The input device may comprise at least one operating element. For example, the operating element may be configured to turn the thermal imaging camera on and/or off, take a photo of a scene, set an operating mode, or activate another function of the thermal imaging camera.

The positioning device mechanically positions the visual assembly to the infrared assembly. By way of example, the positioning device may be configured as a type of frame, shell or canister. The positioning device may be formed about the optical axis. In addition, the positioning device is configured to thermally insulate the infrared assembly from the visual assembly. Further, the positioning device is configured to reduce interference radiation on the infrared assembly. The positioning device is made primarily from a non-heat-conductive, i.e. heat insulating, material. Because of this, the positioning device may thermally decouple the cooling element from the front bracket.

The energy supply unit is equipped for battery operation by way of batteries, for operation by rechargeable batteries with rechargeable battery packs, in particular hand-held power tool rechargeable battery packs and/or for plug-in operation. The power supply unit is provided at least for supplying power to the thermal imaging camera. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell can, for instance, be configured as a Li-ion battery cell having a nominal voltage of 3.6 V. The hand-held power tool rechargeable battery pack can include up to ten battery cells, for example, although a different number of battery cells is conceivable too. Both an embodiment as a cordless hand-held power tool and operation as a mains-operated hand-held power tool are sufficiently well-known to those skilled in the art, so the specifics of the power supply will not be discussed here.

The sensor mount connects the infrared assembly to the cooling element. The cooling element is configured to cool at least the infrared assembly. The cooling element dissipates heat from the infrared assembly. The cooling element may be disposed opposite to the front bracket, in particular substantially inside the housing. The cooling element may be disposed axially along the optical axis between the front bracket and the output device. The cooling element is made of a thermally conductive material. The cooling element absorbs and dissipates heat from at least the visual assembly and the infrared assembly to reduce, in particular to minimize, thermal interference. The sensor mount is configured to protect the infrared assembly from mechanical influences, such as impacts. The sensor mount is configured such that the mechanical influences on the infrared assembly can be absorbed by the sensor mount and conducted to the cooling element. The sensor mount additionally protects the infrared assembly from interfering thermal variables. Thus, the sensor mount protects the infrared assembly from substantially direct thermal radiation on the infrared sensor. Thermal interfering variables may be absorbed by the sensor mount and evenly distributed across the cooling element.

In one embodiment of the thermal imaging camera, the sensor mount comprises an infrared assembly receptacle configured to receive and position the infrared assembly relative to the cooling element. The infrared assembly receptacle may at least partially receive the infrared assembly. Further, the infrared assembly receptacle may at least partially surround the infrared assembly. For example, the infrared assembly may be bolted, glued, clamped, or latched to the infrared assembly receptacle. The infrared assembly receptacle may be configured, for example, in the manner of a shell, pot, or shaft.

In one embodiment of the thermal imaging camera, the thermal imaging camera comprises at least one thermally conductive element disposed between the infrared assembly and the sensor mount. The thermally conductive element may be disposed axially to the optical axis between the infrared assembly and the sensor mount. The thermal conductive element may be disposed between the infrared circuit board and the sensor mount. The thermally conductive element is configured to conduct heat from the infrared assembly to the cooling element. The thermally conductive element is made of a thermally conductive material. The thermally conductive element may be substantially disposed in the infrared assembly receptacle. The thermally conductive element avoids selective heat transitions and allows for even heat distribution to the cooling element.

In one embodiment of the thermal imaging camera, the infrared assembly receptacle is configured to receive the thermally conductive element. The infrared assembly receptacle receives the thermally conductive element, wherein the thermally conductive element can be mounted in at least a positive-locking manner. It is contemplated that the thermally conductive element is connected to the infrared assembly receptacle in a materially-locked fashion. The thermally conductive element is arranged, in particular axially, between the infrared assembly receptacle and the infrared assembly. The thermally conductive element abuts the infrared assembly receptacle. The thermally conductive element abuts the infrared assembly, in particular the infrared circuit board.

In one embodiment of the thermal imaging camera, the sensor mount comprises at least one conduit configured to guide at least one infrared assembly cable of the infrared assembly. The conduit is configured to guide the infrared assembly cable from the infrared assembly towards the control unit. It should be possible to guide the infrared assembly cable with as few obstacles as possible from the infrared assembly in the direction of the control unit in order to avoid the absorption of thermal interference. The sensor mount may form the conduit. For example, the sensor mount may be connected to the conduit or may be integral. The conduit can be configured as an opening, a shaft or a recess, for example. The conduit can be round, elliptical or polygonal, for example. A cover element can be provided above the conduit. The cover element may be configured to avoid air flows through the conduit. For example, the cover element may be made of foam or the like. The cover element can be connected to the conduit in a material-locking fashion. In addition, the cover element is configured to reduce mechanical stress on an infrared assembly connector during mechanical movement of the infrared assembly cable, such as if the thermal imaging camera falls.

In one embodiment of the thermal imaging camera, the sensor mount comprises at least one cable fixation that at least partially fixes the infrared assembly cable to the sensor mount. The cable fixation fixes the infrared assembly cable such that the infrared assembly cable remains substantially fixed in the housing when the thermal imaging camera moves, such as if the thermal imaging camera falls. This may avoid thermal and/or electrical contacts between the components. For example, the cable fixation may be configured as a clasp, wherein other shapes are contemplated. For example, the cable fixation may comprise an adhesive pad connecting the cable fixation to the sensor mount. The cable fixation may be connected to the sensor mount in at least a positive-locking manner, wherein force-locking and/or material-locking connections are also conceivable.

In one embodiment of the thermal imaging camera, the cooling element forms the sensor mount. The cooling element and the sensor mount may be integral. The infrared circuit board can then be arranged axially to the optical axis between the infrared lens and the cooling element. In addition, the thermally conductive element may be arranged between the infrared circuit board and the cooling element.

In one embodiment of the thermal imaging camera, the cooling element comprises at least one cooling fin. A plurality of cooling fins may be provided. It is possible, for example, that two, three, four or more than four cooling fins are provided. The cooling fins may enclose the infrared assembly cable. It is possible that the infrared assembly cable may be able to be fed through three of the cooling fins. For example, the cooling fins may extend along the optical axis towards the control unit. For example, the cooling fins may be T-shaped, double T-shaped, F-shaped, I-shaped, or L-shaped.

In one embodiment of the thermal imaging camera, at least two of the cooling fins are configured opposite to each other. In this case, the two cooling fins may be radially spaced apart from each other relative to the optical axis.

In one embodiment of the thermal imaging camera, the cooling element comprises at least one cuboid cooling cavity. The cuboid cooling cavity may extend axially along the optical axis. The cooling cavity can be connected to the cooling element in a form-locking, force-locking and/or material-locking manner. It is possible for the cooling element to form the cooling cavity so that it is integral. For example, two cooling cavities are provided, wherein more than two cooling cavities are also contemplated. The cooling cavity can be arranged radially, in particular relative to the optical axis, offset from the cooling fin. The cooling fins and the cooling cavities may form a heat sink geometry. The cooling element may form both the cooling fins and the cooling cavities.

### BRIEF DESCRIPTION OF THE DRAWINGS

The disclosure is explained in more detail in the following with reference to a preferred embodiment. In the following, the drawings show:

FIG. 1a a schematic front view of a thermal imaging camera according to the disclosure;

FIG. 1b a schematic rear view of a thermal imaging camera according to the disclosure;

FIG. 2 a section of a longitudinal sectional view of the thermal imaging camera;

FIG. 3 an exploded view of a front bracket, a positioning device, a sensor mount, a cooling element, an infrared assembly, and a visual assembly;

FIG. 4a a perspective view of the infrared assembly, the sensor mount, and the cooling element;

FIG. 4b a side view of the infrared assembly, the sensor mount, and the cooling element;

FIG. 5a a front view of the sensor mount and the cooling element;

FIG. 5b a perspective rear view of the cooling element;

### DETAILED DESCRIPTION

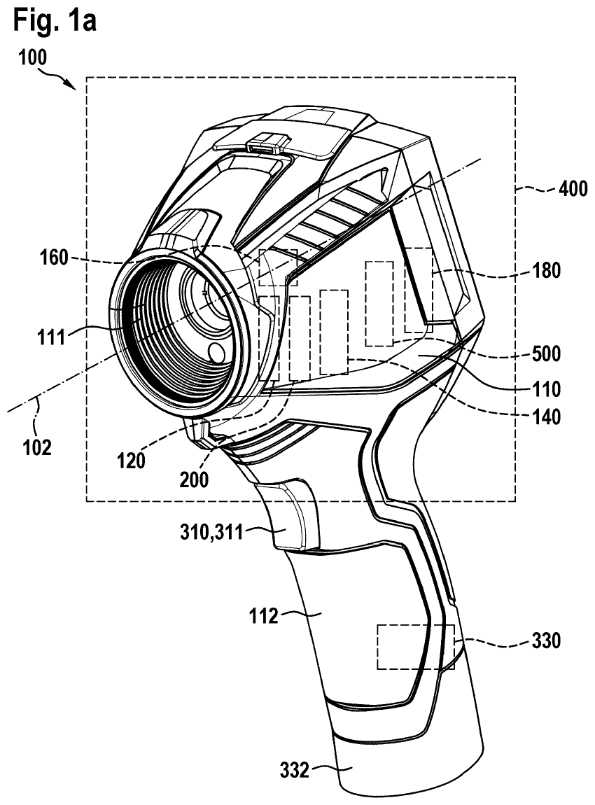

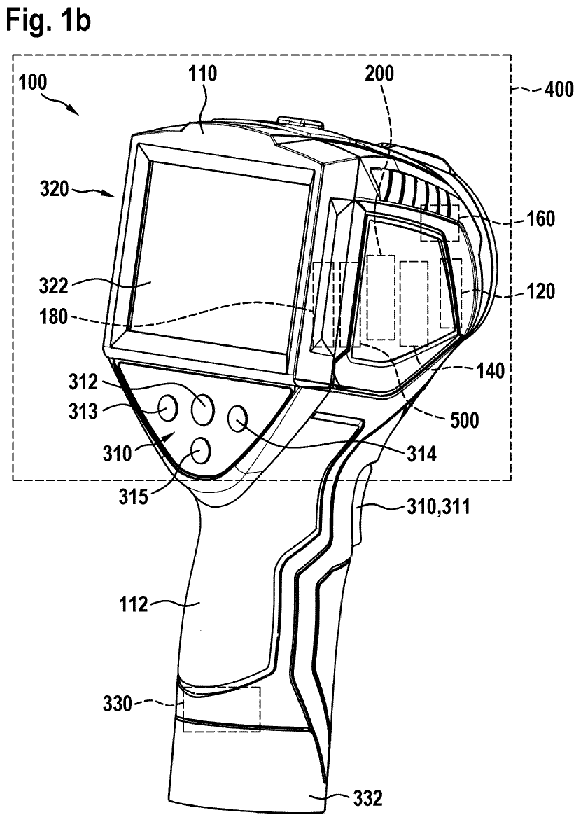

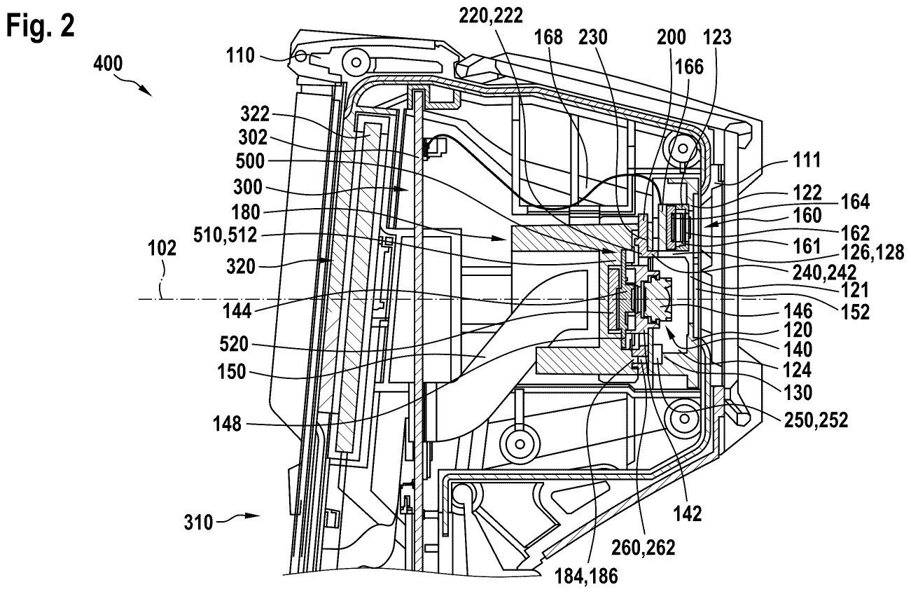

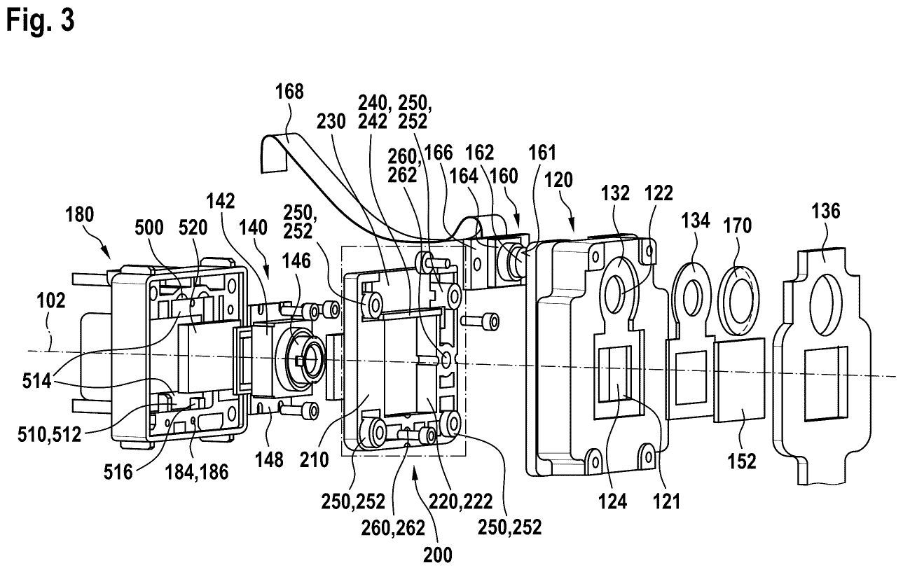

FIG. 1a shows a schematic front view of a thermal imaging camera 100 according to the disclosure, wherein FIG. 1b shows a schematic rear view of the thermal imaging camera 100. The thermal imaging camera 100 here is formed as a handheld thermal imaging camera 100, for example. The thermal imaging camera 100 comprises a housing 110, a front bracket 120, an infrared assembly 140 for detecting infrared radiation, a visual assembly 160 for receiving visual radiation, and at least one cooling element 180 for cooling at least the infrared assembly 140, see also FIGS. 2 to 5. The infrared assembly 140 and the visual assembly 160 are substantially disposed within the housing 110. The thermal imaging camera 100 comprises a positioning device 200, see also FIGS. 2 and 3. The positioning device 200 is provided to position the visual assembly 160 to the infrared assembly 140. The thermal imaging camera 100 comprises a sensor mount 500, see also FIGS. 2 to 5. The sensor mount 500 is provided to connect the infrared assembly 140 to the cooling element 180.

The housing 110 is formed as a shell housing with two half shells. The housing 110 also comprises a handle 112. The front bracket 120, the cooling element 180 and the positioning device 200 are substantially disposed within the housing 110, see also FIGS. 2 and 3. The housing 110 receives a control unit 300, an input device 310, an output device 320, a power supply unit 330, and an evaluation unit, which is not shown. For example, the input device 310 comprises five operating elements 311, 312, 313, 314, 315, see also FIG. 1b. The five operating elements 311, 312, 313, 314, 315 are provided to operate the thermal imaging camera 100. A first operating element 311 is configured as a trigger by which images may be taken. A second operating element 312 is configured as a button by which a user can turn the thermal imaging camera 100 on and off and access a menu selection. A third operating element 313 and a fourth operating element 314 are configured to switch between operating modes within the menu selections. A fifth operating element 315 is configured to confirm and activate a desired operating mode. The assignments of the operating elements 311, 312, 313, 314, 315 are only examples here, so that it is clear to the person skilled in the art that the assignments may also be different. The output device 320 is provided to represent two-dimensional temperature information, in particular a thermal image, and to provide and display information to the user. The output device 320 is formed as a display 322, for example, see FIG. 1b. The output device 320 is disposed opposite to the front bracket 120 on the housing 110. The power supply unit 330 is configured for battery operation using a hand-held power tool rechargeable battery pack 332. The power supply unit 330 is configured to at least supply power to the thermal imaging camera 100. The housing comprises an inlet opening 111. Visual radiation and/or infrared radiation may enter the inlet opening 111. The infrared assembly 140 defines an optical axis 102 that is a primary direction of incidence for the infrared radiation and/or the visual radiation through the inlet opening 111.

FIG. 2 shows a section 400 of a longitudinal sectional view of the thermal imaging camera 100. The cooling element 180 is formed to cool at least the infrared assembly 140, wherein it is made from a thermally conductive material. The cooling element 180 is disposed opposite the front bracket 120. The cooling element 180 is disposed axially along the optical axis 102 between the front bracket 120 and the output device 300. The housing 110 receives the front bracket 120. The front bracket 120 comprises an opening 121 for the infrared assembly and an opening 122 for the visual assembly 160. The front bracket 120 comprises a receptacle 123 for the visual assembly 160. The receptacle 123 for the visual assembly 160 at least partially surrounds the visual assembly 160. The visual assembly 160 abuts the receptacle 123 of the front bracket 120 by way of an end face 161. The visual assembly 160 abuts the front bracket 120 by way of a visual lens 162. The visual assembly 160 comprises a visual camera 164 for capturing at least one image and/or video in the visual spectrum of radiation, the lens 162 for the visual camera 164, and a circuit board 166 for the visual camera 164. The visual assembly 160, in particular the circuit board 166 for the visual camera 164, is connected to the controller 300 to receive signals by way of a cable 168.

The infrared assembly 140 comprises an infrared housing 142, an infrared sensor 144, an infrared lens 146, an infrared circuit board 148, and an infrared assembly cable 150. The infrared housing 142 positions the infrared lens 146 relative to the infrared sensor 144. The infrared sensor 144 is formed as an infrared detector array. To measure infrared radiation, the thermal imaging camera 100 comprises the infrared assembly 140 as well as the evaluation unit. The infrared assembly 140 is connected to the evaluation unit by way of the infrared assembly cable 150, wherein the control unit 300 comprises the evaluation unit. The infrared lens 146 bundles incident infrared radiation through the inlet opening 111 and directs it to the infrared sensor 144. The infrared sensor 144 is disposed on the infrared circuit board 148, wherein the infrared sensor 144 is disposed between the infrared circuit board 148 and the infrared lens 146. The infrared circuit board 148 is connected to the controller 300 by way of the infrared assembly cable 150. The infrared assembly 140 at least partially engages in a recess 124 of the front bracket 120, wherein the infrared assembly 140 engages in the recess 124 by way of the infrared lens 146.

The control unit 300 is connected to the infrared assembly 140 to receive signals by way of the infrared assembly cable 150 and to the visual assembly 160 by way of the cable 168. The control unit 300 comprises a main circuit board 302 that is disposed opposite the front bracket 120. The main circuit board 302 is disposed, particularly axially to the optical axis 102, between the front bracket 120 and the output device 320. In addition, the main circuit board 302 is disposed axially, particularly to the optical axis 102, between the cooling element 180 and the output device 320.

The positioning device 200 is configured to mechanically position the visual assembly 160 to the infrared assembly 140. The positioning device 200 is, for example, formed as a frame 210, see also FIG. 3. The positioning device 200 is disposed about the optical axis 102 and thermally insulates the infrared assembly 140 from the visual assembly 160. The positioning device 200 thermally decouples the cooling element 180 from the front bracket 120. The positioning device 200 is disposed axially along the optical axis 102 between the front bracket 120 and the cooling element 180.

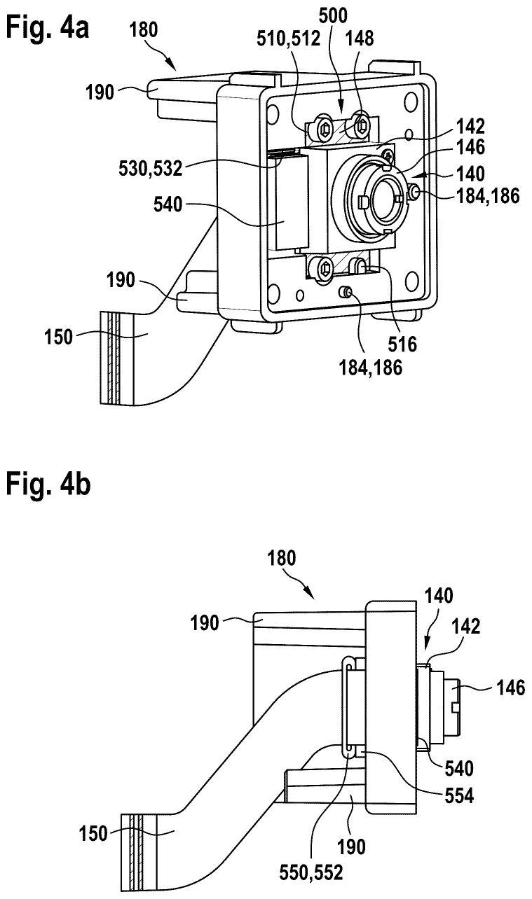

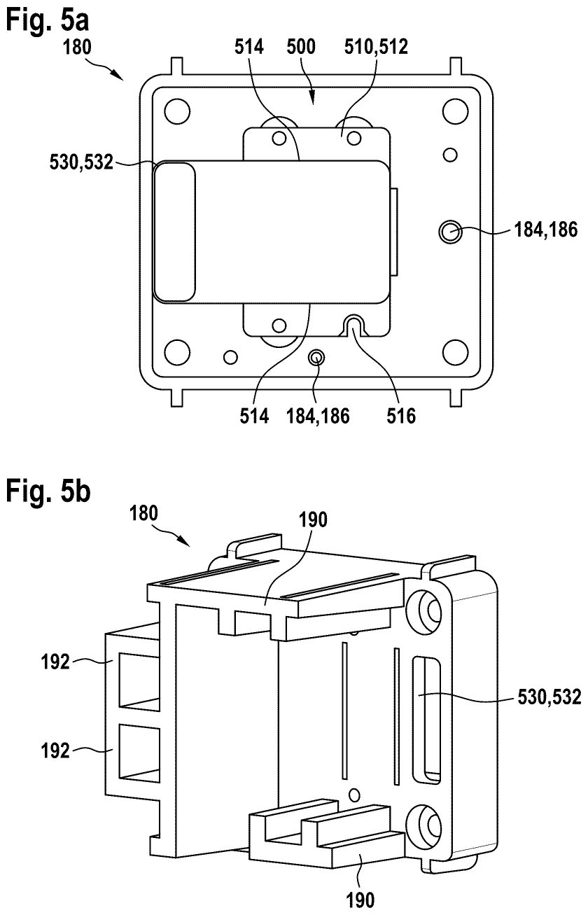

The sensor mount 500 comprises an infrared assembly receptacle 510. The infrared assembly receptacle 510 is formed to receive and position the infrared assembly 140 relative to the cooling element 180. The infrared assembly receptacle 510 at least partially receives the infrared assembly 140. The infrared assembly receptacle 510 at least partially surrounds the infrared assembly 140, see also FIGS. 3 and 4. For example, the infrared assembly 140 is bolted to the infrared assembly receptacle 510. By way of example, the infrared assembly receptacle 510 is formed as a shell 512, see also FIGS. 3 to 5. The shell 512 is here configured with two steps 514 opposite to each other, for example, see FIG. 5. The thermal imaging camera 100 comprises a thermally conductive element 520. The thermally conductive element is disposed between the infrared assembly 140 and the sensor mount 510, wherein the thermally conductive element 520 is disposed axially to the optical axis 102 between the infrared circuit board and the sensor mount 500. The thermally conductive element 520 conducts heat from the infrared assembly 140 to the cooling element 180. The thermally conductive element 520 is formed from a thermally conductive material. By way of example, the thermally conductive element 520 is formed as a thermally conductive pad. The infrared assembly receptacle 510 is provided to receive the thermally conductive element 520, wherein the infrared assembly receptacle 510 receives the thermally conductive element 520 in at least a positive-locking manner. The thermally conductive element 520 is connected to the infrared assembly receptacle 520 in a material-locking manner. The thermally conductive element 520 is disposed between and abuts the infrared assembly receptacle 510 and the infrared assembly 140, particularly the infrared circuit board 148.

The positioning device 200 abuts the cooling element 180 and the front bracket 120 at least in part and/or in sections. In addition, the cooling element 180 at least partially engages with the positioning device 200. The infrared assembly 140 and the visual assembly 160 are arranged as overlapping with one another by way of the positioning device 200, in particular axially along the optical axis 102. Here, at least the infrared lens 146 and the circuit board 166 for the visual camera 164 overlap. The infrared assembly 140 and the visual assembly 160 are disposed radially, particularly with respect to the optical axis 102, spaced apart from one other. The positioning device 200 comprises a receptacle 220 for the infrared assembly 140. The receptacle 220 for the infrared assembly 140 at least partially surrounds, in particular substantially completely surrounds, the infrared assembly 140. The receptacle 220 of the positioning device 200 for the infrared assembly 140 is shaped, for example, as a quadrilateral opening 222, see also FIGS. 3 and 4. The receptacle 220 of the positioning device 200 for the infrared assembly 140 at least partially surrounds the infrared housing 142. The receptacle 220 of the positioning device 200 for the infrared assembly 140 is spaced from the infrared assembly here such that there is a distance between the infrared housing 142 and the receptacle 220. The positioning device 200 comprises a receptacle 230 for the visual assembly 160. The receptacle 230 of the positioning device 200 for the visual assembly 160 surrounds the visual assembly 160 at least in part and receives it at least in part. The visual assembly 160 abuts only part of the receptacle 230 of the positioning device 200 for the visual assembly 160. The receptacle 230 of the positioning device 200 for the visual assembly 160 at least partially surrounds the board 166 for the visual camera 164. The receptacle 220 of the positioning device 200 for the infrared assembly 140 and the receptacle 230 of the positioning device 200 for the visual assembly 160 are radially offset, in particular to the optical axis 102, from one other on the positioning device 200. The receptacle 230 of the positioning device 200 for the visual assembly 160 is, for example, cup-shaped.

The positioning device 200 comprises a shielding element 240. The shielding element 240 is provided to shield the infrared assembly 140 against thermal radiation from the visual assembly 160. By way of example, the positioning device 200 forms the shielding element so that it is a single piece here. The shielding element 240 extends axially along the optical axis 102. The shielding element 240 extends towards the front bracket 120. The shielding element 240 is formed as a shielding bar 242, for example. The front bracket 120 comprises an insulating element 126. The insulating element 126 is provided to insulate the infrared assembly 140. The front bracket 120 forms the insulating element 126 so that it is a single piece. The insulating element 126 extends axially along the optical axis 102 towards the infrared assembly 140 and the cooling element 180. The insulating element 126 is formed as an insulating bar, for example. The shielding element 240 abuts the insulating element 126. The positioning device 200 comprises at least one positioning element 250. The positioning element 250 is provided to position the front bracket 120 relative to the infrared assembly 140 and the visual assembly 160. The positioning device 200 forms the positioning element 250, so that it is a single piece. The positioning element 250 orients the front bracket 120 relative to the infrared assembly 140 and the visual assembly 160 such that the opening 121 in the front bracket 120 for the infrared assembly 140 and the opening 122 in the front bracket 120 for the visual assembly 160 are axially aligned with the infrared assembly 140 and the visual assembly 160, respectively. The positioning element 250 is formed as a screw boss 252, by way of example, wherein four positioning elements 250 are provided here. The positioning element 250 engages in the front bracket 120. The front bracket 120 comprises a receptacle 130 for the positioning element 250. The receptacle 130 for the positioning element 250 receives the positioning element 250 in at least a positive-locking manner. By way of example, four receptacles 130 are formed for each of the positioning elements 250. The cooling element 180 comprises at least one alignment element 184. The positioning device 200 comprises at least one receptacle 260 for the positioning element 184. The positioning element 186 is provided to align the positioning device 200 relative to the cooling element 180 by way of the receptacle 260 for the positioning element 186. The cooling element 180, by way of example, forms the alignment element 184 so that it is a single piece. The positioning element 186 engages with the receptacle 260 of the positioning device 200 for the positioning element 184 in at least a positive-locking manner. The alignment element 184 is shaped as an alignment pin 186, for example. Here, for example, two alignment pins 186 and two receptacles 260 are formed, see also FIGS. 3 to 5. Each of the receptacles 260 is formed as a through-opening 262.

FIG. 3 shows an exploded view of the front bracket 120, the positioning device 200, the sensor mount 500, the cooling element 180, the infrared assembly 140, and the visual assembly 160. The front bracket 120 comprises a further receptacle 132. The further receptacle 132 of the front bracket 120 comprises an adhesive pad 134. The further receptacle 132 of the front bracket 120 is provided to receive an infrared window 152 for the infrared assembly 140 and a glass pane 170 for the visual assembly 160 via the adhesive pad 134. A gasket 136 is affixed to the front bracket 120 to close off the housing 110 against a work environment. The infrared assembly receptacle 510 comprises a receptacle projection 516, see also FIGS. 4 and 5. The receptacle projection 516 is configured to engage with the infrared circuit board 148 and fasten the infrared circuit board 148. The receptacle projection 516 and the infrared assembly receptacle 510 are integral.

FIG. 4a shows a perspective view of the infrared assembly 140, the sensor mount 500, and the cooling element 180 and FIG. 4b shows a side view of the infrared assembly 140, the sensor mount 500, and the cooling element 180. The sensor mount 500 comprises a conduit 530, see also FIG. 5. The conduit 530 is provided to guide the infrared assembly cable 150. There, the conduit 530 guides the infrared assembly cable 150 from the infrared assembly 140 towards the controller 300. The sensor mount 500 forms the conduit 530. By way of example, the conduit 530 is formed as a substantially elliptical opening 532. A cover element 540 is disposed above the conduit 530. The cover element 540 is provided to avoid air flows through the conduit 530. By way of example, the cover element 540 is formed from foam. The cover element 540 is here connected, by way of example, at least partially in a material-locking manner to the conduit 530. The sensor mount 500 comprises a cable fixation 550. The cable fixation 550 at least partially fixes the infrared assembly cable 150 to the sensor mount 500. The cable fixation 500 is formed as a clasp 552, for example. The cable fixation 550 comprises an adhesive pad 554. The adhesive pad 554 is configured to connect the cable fixation 550 to the sensor mount 500. The cable fixation 550 is connected to the sensor mount 500 by way of the adhesive pad 554 in a materially-locked manner.

FIG. 5a shows a front view of the sensor mount 500 and the cooling element 180, wherein FIG. 5b shows a rear perspective view of the cooling element 180. The cooling element 180 forms the sensor mount 500 so that it is integral. The cooling element 180 comprises at least one cooling fin 190, wherein two cooling fins 190 are formed here, by way of example. The cooling fins 190 at least partially surround the infrared assembly cable 150, see also FIGS. 2 to 4. By way of example, the cooling fins 190 are F-shaped. The two cooling fins 190 are disposed opposite to each other on the cooling element 180. The two cooling fins 190 are radially spaced apart from one other to the optical axis 102. The cooling element 180 comprises at least one cuboid cooling cavity 192, wherein two cuboid cooling cavities 192 are formed here. The cuboid cooling cavities 192 extend axially along the optical axis 102. The cooling element 180 forms the cuboid cooling cavities 192 so that they are integral. The cooling cavities 192 are disposed radially offset from the cooling fins 190.

What is claimed is:

1. A thermal imaging camera, comprising:
a housing;
an infrared assembly configured to detect infrared radiation;
a visual assembly configured to receive visual radiation, wherein the infrared assembly and the visual assembly are disposed substantially within the housing;
at least one cooling element configured to cool the at least the infrared assembly; and
a sensor mount configured to connect the infrared assembly to the cooling element.

2. A thermal imaging camera according to claim 1, wherein the sensor mount comprises an infrared assembly receptacle configured to receive and position the infrared assembly relative to the cooling element.

3. A thermal imaging camera according to claim 1, further comprising at least one thermally conductive element disposed between the infrared assembly and the sensor mount.

4. A thermal imaging camera according to claim 2, wherein the infrared assembly receptacle is configured to receive the thermally conductive element.

5. A thermal imaging camera according to claim 1, wherein the sensor mount comprises at least one conduit configured to guide at least one infrared assembly cable of the infrared assembly.

6. A thermal imaging camera according to claim 1, wherein the sensor mount comprises at least one cable fixation that at least partially fixes one infrared assembly conduit to the sensor mount.

7. A thermal imaging camera according to claim 1, wherein the cooling element forms the sensor mount.

8. A thermal imaging camera according to claim 1, wherein the cooling element comprises at least one cooling rib.

9. A thermal imaging camera according to claim 8, wherein at least two of the cooling fins are configured opposite to one other.

10. A thermal imaging camera according to claim 1, wherein the cooling element comprises at least one cuboid cooling cavity.
